(19) United States
(12) Patent Application Publication
(10) Pub. No.: US 2013/0332248 A1
(43) Pub. Date: Dec. 12, 2013

(54) ONLINE ADVERTISEMENT SYSTEM AND METHOD FOR PROVIDING AN ONLINE SERVICE BASED ON A SOCIAL COMMERCE GAME

(71) Applicant: Tae Yeong Lim, Seoul (KR)

(72) Inventor: Tae Yeong Lim, Seoul (KR)

(21) Appl. No.: 14/000,649

(22) PCT Filed: Feb. 17, 2012
(86) PCT No.: PCT/KR12/01229

§ 371 Date: Aug. 21, 2013

(30) Foreign Application Priority Data
Feb. 21, 2011 (KR) 10-2011-0014935

(51) Int. Cl. G06Q 30/02

(52) U.S. Cl. CPC G06Q 30/0251
USPC 705/14.12; 705/14.49

(57) ABSTRACT

This is the invention of the system and method for on-line advertisement involving easy, friendly and non-professional social commerce games such as ‘Rock-Scissors-Paper’, ‘Ladder Game’ or Dice Game’ by which users get interested in, in promotion of participation, and granted incentives according to the performance in the game. In other words, this invention is about favoring both users and advertisers by way of incentivizing participation and offering cost-efficient, methodical and ‘targeted’ means of on-line, real-time advertisement and service thereof.

In establishment thereof, this invention is to establish, in offering the on-line advertisement system and service thereof, an Advertisement Registry, Social Advertisement Server (1) comprising Game Program Operator, Data Collator and Standings Manager, Advertiser's Server and User Server administering users being the subject of advertisement.

In addition, this invention is to further establish a sequence of advertiser registration, advertisement acceptance, participation inducement, game play application, game execution, advertisement exposure and incentive grant.

### TECHNICAL FIELD

This is the invention of the system and method for on-line advertisement involving easy, friendly and non-professional social commerce games such as ‘Rock-Scissors-Paper’, ‘Ladder Game’ or Dice Game’ by which users get interested in, in promotion of participation, and granted incentives in exchange for watching real-time advertisement, as a means of brand-new on-line advertisement model.

### BACKGROUND ART

In the wake of the age of cutting-edge technology where the companies are competing and struggling for existence, the innovative means of marketing is a core of success in responding to rapidly changing market condition and technological background. What comes into play here is ‘inventiveness’ and ‘proactivity’ of marketing, in creation of profitable values between the company and customers.

As far as the information-oriented society goes, the unprecedented development in the computer science and communication media makes feasible the Internet and mobile networks to serve as a means of advertisement, such as on-line banner, e-mail/SMS advertisement.

These conventional means of on-line advertisement, however, barely take effect unless drawing interest and actuating ‘proactivity’ from the nonchalant users, potential customers of the advertisers, who have no option but ‘ignoring information’ in the thick of unilateral, unwanted ads including what are called spams. In such a situation, the conventional means of advertisement serves nothing more than ‘cash-guzzler’ barely working as intended.

Meanwhile, the emergence of ‘smart devices’ and SNS, such as Twitter and Facebook helping solidifying relationship with acquaintances and onset of newer on-line relationships for a wider human network, caused what are called ‘SNS games’ and ‘Social Shopping’ seizing an opportunity to fare. Here, SNS games, based upon such social networking platforms as Facebook, MySpace, Mixi and Cyworld, can be defined as ‘a means of boosting intimacy by and among users open to all comers’, whereas Social Shopping, also referred to as Social Commerce, offers sizable amount of discount on condition of ‘Group Purchase’ where users are voluntarily coming to promote the deal by means of SNSs.

Notwithstanding the above, the modern-day Social Games favors no more than users capitalizing thereon for establishment of human networks, not to mention Social Commerce benefiting users with discount but never incentivizing users' voluntary behaviors promoting the deal unless concluding the purchase out of the deal.

This comes more significant when considering the service providers of Social Commerce receiving the considerable amount of advertisement fees and commissions upon purchase, leaving the users involved in the voluntary promotion of the deal marginalized. Plus, the present Social Commerce establishes nothing more than superior-subordinate relation between the service provider and advertiser through which money flow unilaterally, also leaving users, the potential customers in other words, nonchalant and rooms for the potentially innovative system which may better actuate users to ‘come into play’.

Necessity to getting over all these inefficiencies has been raised by numerous advertisers demanding cost-efficient and innovative means of advertisement targeting their potential customers who are granted an opportunity to earn some, more specifically incentivized in exchange of their voluntary participation in promoting deals, for the eventual ‘all-equal’, cost-efficient and reasonable means of on-line advertisement.

### DISCLOSURE OF INVENTION

### Technical Problem

This Invention is to solve such problems as the conventional on-line, SNS-based advertisement systems and services thereof.

More specifically, this invention is about the innovative system and method for on-line advertisement involving easy, friendly and non-professional social commerce games as ‘Rock-Scissors-Paper’, ‘Ladder Game’ or Dice Game’ open to all corners, featuring the simplest interface and granting incentives to the participants upon performance, such as bus not limited to price discount, voucher an cash gift, for users to get interested in which may lead not only to the active participation and voluntary promotion by users but to the natural exposure of such advertisement data as products, businesses and technologies of the advertiser. In other words, this invention is about favoring both users and advertisers by way of incentivizing participation and offering cost-efficient, methodical and ‘targeted’ means of on-line, real-time advertisement and service thereof.

Moreover, this invention is to offer the on-line advertisement system and service thereof, without limitation to the daily participation, grant all those willing and applying for the participation, in promotion of interest and expectation by users to maximize the advertisement effect.

Last but not least, this invention is, in offering the on-line advertisement system and service thereof, to revert a part of incentives to users to accumulating the donation for the sake of not only users but social benefit.

### Technical Solution

In establishment thereof, this invention is to establish, in offering the on-line advertisement system and service thereof, an Advertisement Registry, Social Advertisement Server (1) comprising Game Program Operator, Data Collator and Standings Manager, Advertiser's Server and User Server administering users being the subject of advertisement.

In addition, this invention is to further establish a sequence of advertiser registration, advertisement acceptance, participation inducement, game play application, game execution, advertisement exposure and incentive grant.

### Advantageous Effects

For such purposes, this invention is to incorporate a social commerce competition (hereinafter referred to as the ‘game’ open to all corners, granting the participants an opportunity to be incentivized by where they stand, causing advertisements from the Advertisement Server exposed to them induced to play in with interest in maximization of the advertisement efficiency, while favoring both users and advertisers by way of incentivizing participation and offering cost-efficient, methodical and ‘targeted’ means of on-line, real-time advertisement and service thereof.

Also, this invention is to offer the on-line advertisement system and service thereof, without limitation to the daily participation, grant all those willing and applying for the participation, in promotion of interest and expectation by users to maximize the advertisement effect.

Meanwhile, this invention is, in promisingly offering the on-line advertisement system and service thereof, to revert a part of incentives to users to accumulating the donation for the sake of not only users but social benefit.

### BRIEF DESCRIPTION OF THE DRAWINGS

FIG. 1 represents Composition of the On-line Advertisement System based upon Social Commerce Game.

FIG. 2 represents Rough Map of Social Advertisement Server herein.

FIG. 3 represents Rough Map of User Server herein.

FIG. 4 represents Conceptual Map of the On-line Advertisement System based upon Social Commerce Game.

FIG. 5 represents the list of matches for competition.

FIG. 6 represents Flow Chart of the On-line Advertisement System based upon Social Commerce Game.

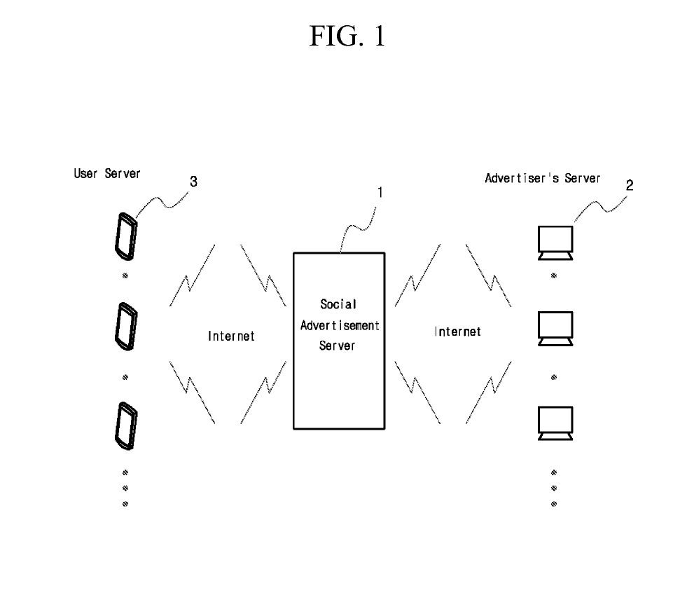

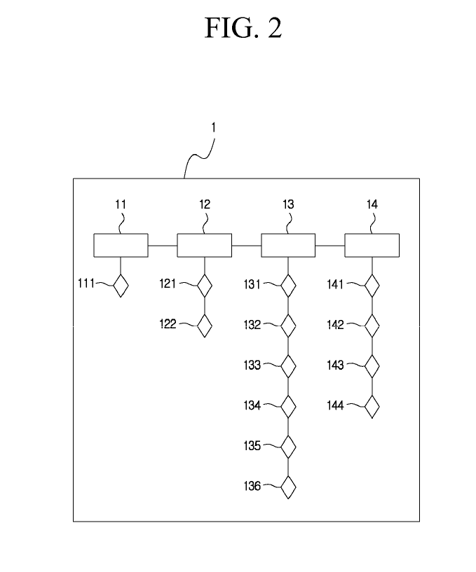

### MODE FOR CARRYING OUT THE INVENTION

This invention can be broken down as follows, as backed by the drawings, for an On-line Advertisement System based upon Social Commerce Game.

As briefly set forth above, this invention comprises, as broadly classified, Social Advertisement Server (1), Advertiser's Server (2) and User Server (3).

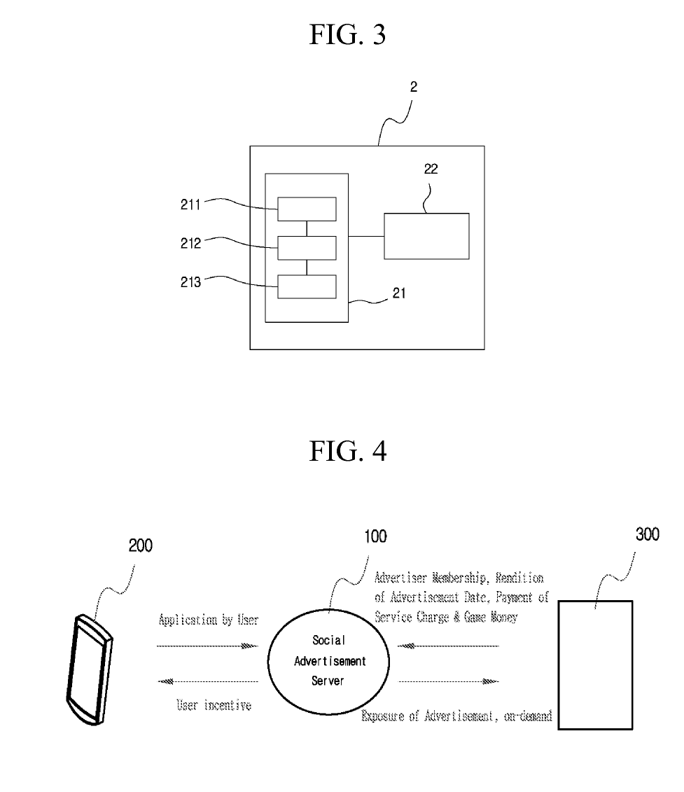

Here, Social Advertisement Server (1), among others and as the main part of the invention, causes the duly registered advertisement exposed to social commerce for ‘random exposure’ to the corporate and distributor servers in maximization of the advertisement effect, according to request by advertisers, etc. registered on Advertiser's Server (2) mentioned below.

Whereas, the said Social Advertisement Server (1) comprises Data Auto-processor (11), the essential component, and preferable Advertisement Registry (12), Game Program Operator (13) and Standings Manager (14).

Whereas, the said Data Auto-processor (11) of Social Advertisement Server (1) categorizes Advertiser's Server (2) and User Server (3), described hereunder, into the type of services involved for real-time linkage therebetween, by way of a server capable of User Administration Mode (111) to cause sending of text (SMS), messages, e-mail, audio-visual contents or steel images and operation of web-browsable menus feasible.

Whereas, the said Advertisement Registry (12) of Social Advertisement Server (1) causes the random Advertisers' Servers (2) registered thereon, in promotion of the social commerce-based advertisement, by comprising, as set forth in FIG. 3, Registration Mode (121) and Advertisement DB (122) as part thereof.

Whereas, the said Game Program Operator (13) of Social Advertisement Server (1) offers the game played by the voluntarily motivated User Servers (3), described hereunder, by comprising Game Generator Mode (131), Game Selector Mode (132), Rule Selector Mode (133), Program Distribution Mode (134), Matcher Mode (135) and Advertisement Setting Mode (136) as part thereof.

Whereas, the said Standings Manager (14) of Social Advertisement Server (1) collates the game data by comprising Result Display Mode (141), Donation Selector Mode (142), Prize Award Mode (143) and Donation Award Mode (144) as part thereof.

Whereas, the said Advertiser's Server (2), referring to all those random advertisers willing to promote products and/or technologies, such as but not limited to the corporate or distributor server, comprises, as set forth in FIG. 3, Advertisement Generator (21), taking Image Processor Mode (211), Texting Mode (212) and Editor Mode (213) as the essential part thereof, and preferable Advertisement Sender (22) sending out the generated advertisement data to the said Social Advertisement Server (1).

Whereas, the said User Server (3) refers to all those random web servers, such as but not limited to smartphone, netbook, personal computers and other terminals on-line, wishing making profits out of social commerce activities and preferable comprises software and application programs accessible to the SNSs such as Twitter Application and Facebook Application.

So far is the composition of the invention establishing the discriminated type of on-line advertisement service by way of what is called ‘social commerce game’, as referred to in drawings attached hereto.

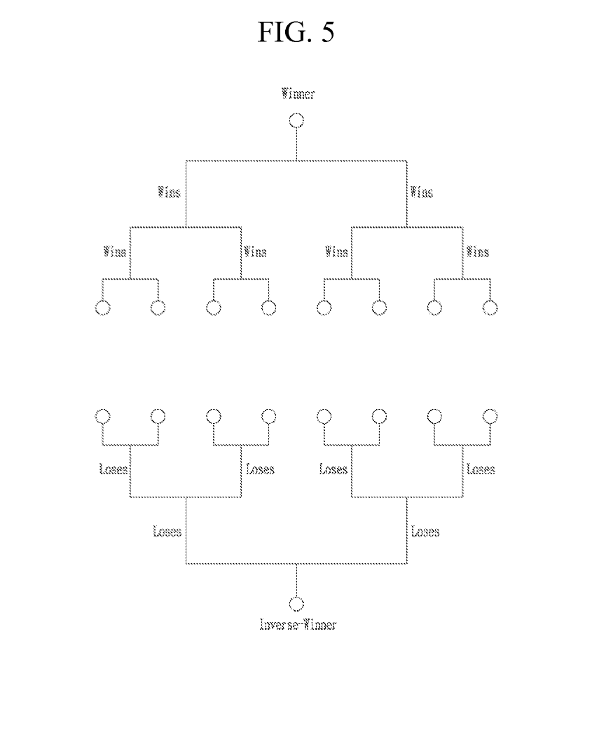

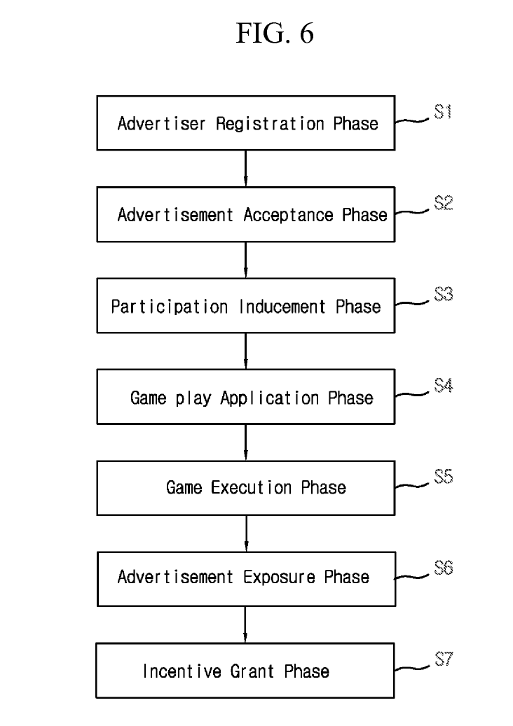

Refer to FIG. 4 for Conceptual Map of the On-line Advertisement System based upon Social Commerce Game, FIG. 5 for the list of matches for competition and FIG. 6 for Flow Chart of the On-line Advertisement System based upon Social Commerce, where;

The system works by way of Advertiser Registration (S1), Advertisement Acceptance (S2), Participation Inducement (S3), Game Play Application (S4), Game Execution (S5), Advertisement Exposure (S6) and Incentive Grant Phases (S7).

Here, the said Advertiser Registration Phase (S1) causes the random number of Advertiser's Servers (2), referring to all those random advertisers willing to promote products and/or technologies, to stay on-line on the said Social Advertisement Server (1) preferably on condition of applying through Registration Mode (121) of Advertisement Registry (12) for the eventual registration on the Server.

The application made by the said Advertiser's Server(s) (2) through Registration Mode (121) of Advertisement Registry (12) should include, but not limited to, the name of company (or individual), address and Business Registration Number, from time to time supplemented by the scope of advertisement exposure and money deposit for user incentivization (game money) and service charge which later should be transmitted to the account opened in the name of the said Social Advertisement Server (1).

For instance, an Advertiser's Server (2) wishing the advertisement exposed to 100,000 users on a daily basis may configure the said money deposit for KRW 1,000,000, KRW 10 per user, plus the service charge which later should be transmitted to the account opened in the name of the said Social Advertisement Server (1).

For another instance, an Advertiser's Server (2) wishing 5-day exposure of advertisement to 100,000 users on a daily basis may configure the said money deposit for KRW 5,000,000, KRW 10 per user for 5-day span, plus the service charge which later should be transmitted to the account opened in the name of the said Social Advertisement Server (1).

Notwithstanding the above, this Invention shall include the all-inclusive type of payment settled by an Advertiser's Server (2) to Social Advertisement Server (1) who may on its discretion execute and partition the amount paid for the service charge and user incentivization (game money).

For instance, an Advertiser's Server (2) settling the all-inclusive amount worth KRW 1,000,000 may grant a right to a Social Advertisement Server to execute and partition the amount paid half and half, for the service charge reverted thereto and game money reserved for user incentivization.

Meanwhile, the said Advertisement Acceptance Phase (S2) causes the duly registered Advertiser's Server (2), by way of the said Advertiser Registration Phase (S1), to prepare for advertisement data by Advertisement Generator (21) for rendition to Advertisement DB (122) of Advertisement Registry (12) for data storage.

For instance, an Advertiser's Server (2) may prepare for advertisement data, by way of Image Processor Mode (211) of Advertisement Generator (21), by imagery, text and audio-visual means maximizing the advertisement effect, which should later be edited on Editor Mode (213) in conclusion of advertisement data.

Meanwhile, the said Participation Inducement Phase (S3) develops user-inductive and motivating game, by way of Game Generator Mode (131) of Game Program Operator (13) set established within Social Advertisement Server (1) and configures rule, time, player limit and prize money of the game on Rule Selector Mode (133), preferably comprising Data Auto-processor (11) of Social Advertisement Server (1) sending out SMSs, e-mail or voice call in promotion of the game.

For instance, an Advertiser's Server (2) configuring the scope of exposure at 100,000 users a day by way of the said Advertiser Registration Phase (S1), developing a ‘One-on-One Tournament Game’ by way of Rule Selector Mode (133), accepting the participation in order of application and setting prize money out of the amount paid to the Social Advertisement Server (1), say KRW 1,000,000, may send SMSs, e-mail or voice call to the effect promoting the service, say “Prize up for grabs. Be a part of the game!”, targeting the random User Servers (3), where;

Social Advertisement Server (1), in promotion of the service to the said random User Servers (3), selectively send SMSs, e-mail or voice call to the random number of people for them to spread out by SNS for the eventual advertisement effect.

For instance, the potential users might be motivated to spread the service out to, by way of SNSs, the random people wanting to secure their chance to win the prize by ensuring the game to take place with the sufficient number of users participating in. This, by the process of drawing interests from the potential users also being potential customers of Advertiser's Servers (2) who may up the maximum number of the participants and prize money, may actuate the voluntary behavior of the users in promotion of the service to secure chances to win the prize on their own or for their acquaintances.

In addition, this invention should involve easy, friendly and non-professional social commerce games, developed by way of the said Game Generator Mode (131), such as ‘Rock-Scissors-Paper’, ‘Ladder Game’, ‘Dice Game’, ‘Pairing Game’ and any other type of games involving competition. Notwithstanding the above, this invention shall include the type of program involving multiple choices of games selectable by users.

Meanwhile, the said Game Play Application Phase (S4) preferably causes User Servers (3), induced by way of the said Participation Inducement Phase (S3) accessing the game by way of such SNS programs and applications as Twitter Application and Facebook Application while let the SNS acquaintances, previously unaware as omitted by Social Advertisement Server (1), know of the service to induce the User Servers (3) on-line take part in the game by way of Game Selector Mode (132) of the said Game Program Operator (13).

Here, the said User Servers (3), in application for playing the game, should provide such personal information as name, age, gender, mobile contact, address and e-mail by way of User Administration Mode (111) of the said Data Auto-processor (11), to which such information is stored, to be entitle to win the prize money.

Also, the entitlement to play the game may be granted multiple times in a day, without respect to the performance and period of participation, to cause users stay interested, based upon the said information of User Servers (3) stored in the said Data Auto-processor (11).

Meanwhile, the said Game Execution Phase (S5) assigns the said information of User Servers (3) to Matcher Mode (135) of Game Program Operator (13) of Social Advertisement Server (1), causing the concerned User Servers (3) accessing the said Social Advertisement Server (1) at the predetermined time to play the game, preferably until concluding the sole winner atop.

Here, the tournament structure shall not be limited thereto but extending to double-elimination-type, as set forth in FIG. 5 to cause defeated users stay interested to win the title of ‘Inverse-winner’, which shall constitute a part of this invention.

In addition, idling or disconnected users from the said Social Advertisement Server (1) should be deemed defeated in the game, while determining ‘winner by default’, in case of draw, etc., ‘in order of access’ to induce the User Servers keep staying on-line and more exposed to the advertisement.

Meanwhile, the said Advertisement Exposure Phase (S6) sets the time and method of advertisement data, rendered the Advertiser's Server (2), exposed by way of Advertisement Setting Mode (136) of the said Game Program Operator (13) to the webpage run by the said Social Advertisement Server (1).

For instance, the User Servers (3) are willing to access earlier than the projected commencement of the game, say 1 A.M., to claim the state accessing earlier, giving text or audio-visual advertisements opportunities to be exposed to them. In addition, the said advertisements may contain ‘Avatar’ of users to draw interest and from time to time be exposed during the course of the game, upon transition of screen, etc., for the sustainable exposure capitalizing on the webpage run by the said Social Advertisement Server (1).

Last but not least, the said Incentive Grant Phases (S7) aggregates and sends the performance of users and process and results of the game via Standings Manager (14) to the participating User Servers (3), calculates the prize money via Prize Award Mode (143) and transmits the calculated amount to the account opened in the name of the winner.

Here, a part of the prize money should be deducted, by Donation Award Mode (144) at a rate duly set and configured by the said Social Advertisement Server (1), in the name of ‘donation’ for the society's sake which shall constitute a part of this invention.

In addition, the said Game Execution Phase (S5) may, in provision of the foresaid service, comprise a means to vie with the virtual contender, established by the said Social Advertisement Server (1), in prevention of ‘win-by-default’ from time to time happening over the process of tournament game.

Also, in the eventual prevention of ‘win-by-default’ situation for the fairness of the game, the said Social Advertisement Server (1) may further comprise a means to control the number of participants, by way of the mathematical calculation processed by Rule Selector Mode (133).

For instance, the number of participants of the game may be set 1,024, which weeds out 512 participants for Round 2, 256 for Round 3, 128 for Round 4, 64 for Round 5, 32 for Round 6, 16 for Round 7, 8 for Round 8, 4 for Round 10, 2 for Round 10 and one last eliminate for Round 11 in prevention of win-by-default situation for every Round.

1. A method for on-line advertisement system using social commerce game, featuring:
a Social Advertisement Server comprising Data Auto-processor as an essential component thereof and preferable options of Advertisement Registry, Game Program Operator and Standings Manager;
an Advertiser's Server accessing the said Social Advertisement Server, to which transferring and registering the advertisement data, by way of Data Auto-processor; and
a User Server accessing the said Social Advertisement Server by way of Data Auto-processor for registration of game player and reception of real-time advertisement data by way of game play.

2. As for the said claim 1, a method for on-line advertisement using social commerce game, featuring:
a Game Program Operator of Social Advertisement Server, comprising Game Generator Mode, Game Selector Mode, Rule Selector Mode, Program Distribution Mode, Matcher Mode and Advertisement Setting Mode as part thereof.

3. As for the said claim 1, a method for on-line advertisement using social commerce game, featuring:
a Standings Manager of Social Advertisement Server, Result Display Mode, Donation Selector Mode, Prize Award Mode and Donation Award Mode as part thereof.

4. As for the said claim 1, a method for on-line advertisement using social commerce game, featuring:
the said Advertiser's Server comprising Advertisement Generator, taking Image Processor Mode, Texting Mode and Editor Mode as the essential part thereof, and preferable Advertisement Sender sending out the generated advertisement data to the said Social Advertisement Server.

5. A method for on-line advertisement using social commerce game, featuring:
an Advertiser Registration Phase causing Advertiser's Servers, referring to all those random advertisers willing to conduct social-commerce on-line advertisement products, registered Registration Mode of Advertisement Registry;
an Advertisement Acceptance Phase causing the duly registered Advertiser's Server to prepare for advertisement data by Advertisement Generator for rendition to Advertisement DB of Advertisement Registry of Social Advertisement Server for data storage;
a Participation Inducement Phase developing user-inductive and motivating game, by way of Game Generator Mode of Game Program Operator set established within Social Advertisement Server and configuring rule, time, player limit and prize money of the game on Rule Selector Mode, preferably comprising Data Auto-processor of Social Advertisement Server sending out information to User Servers in promotion of the game;
a Game Play Application Phase preferably causing User Servers, induced by way of the said Participation Inducement Phase accessing the game by way of such SNS programs and applications as Twitter Application and Facebook Application while let the SNS acquaintance know of the service to induce the User Servers on-line take part in the game by way of Game Selector Mode of the said Game Program Operator;
a Game Execution Phase assigning the said information of User Servers to Matcher Mode of Game Program Operator of Social Advertisement Server and causing the concerned User Servers accessing the said Social Advertisement Server at the predetermined time to play the game, preferably until concluding the sole winner atop;
an Advertisement Exposure Phase setting the time and method of advertisement data, rendered the Advertiser's Server, exposed by way of Advertisement Setting Mode of the said Game Program Operator to the webpage run by the said Social Advertisement Server; and
an Incentive Grant Phases aggregating and sending the performance of users and process and results of the game via Standings Manager to the participating User Servers, calculating the prize money via Prize Award Mode and transmitting the calculated amount to the account opened in the name of the winner.

6. As for the said claim 5, a method for on-line advertisement using social commerce game, featuring:
an Advertiser's Server, over the course of the said Advertiser Registration Phase receiving personal information and the desired scope of advertisement exposure, by which the service charge shall be determined, through Registration Mode of Advertisement Registry.

7. As for the said claim 5, a method for on-line advertisement using social commerce game, featuring:
a Participation Inducement Phase involving multiple choices of games, selectable among easy, friendly and non-professional social commerce games, developed by way of the said Game Generator Mode, such as ‘Rock-Scissors-Paper’, ‘Ladder Game’, ‘Dice Game’, ‘Pairing Game’ and any other type of games involving competition, by user.

8. As for the said claim 5, a method for on-line advertisement using social commerce game, featuring:
a Participation Inducement Phase calculating the prize money, by Rule Selector Mode, based upon the amount settled, by the said Advertiser's Server for incentivizing User servers, worth equally distribution to the entire of participants.

9. As for the said claim 5, a method for on-line advertisement using social commerce game, featuring:
a Game Execution Phase featuring both tournament ladder-type and double-elimination-type to determine the sole ‘Inverse-winner’ granting no points over the course of the game.

10. As for the said claim 5, a method for on-line advertisement using social commerce game, featuring:
an Incentive Grant Phases deducting and accumulating a part of the prize money, by Donation Award Mode at a rate duly set and configured by the said Social Advertisement Server, in the name of ‘donation’.
